(19) United States
(12) Patent Application Publication
(10) Pub. No.: US 2007/0031052 A1
(43) Pub. Date: Feb. 8, 2007

(54) Morphological significance map coding using joint spatio-temporal prediction for 3-d overcomplete wavelet video coding framework

(75) Inventors: Deepak S. Turaga, Elmsford, NY (US); Mihaela Van Der Schaar, Sacremento, CA (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/573,550

(22) PCT Filed: Sep. 24, 2004
(86) PCT No.: PCT/IB04/51857

§ 371 Date: Mar. 27, 2006

Related U.S. Application Data
(60) Provisional application No. 60/506,882, filed on Sep. 29, 2003.

(51) Int. Cl. G06K 9/46; G06K 9/36

(52) U.S. Cl. 382/240; 382/236

(57) ABSTRACT

A system and method is provided for digitally encoding video signals within an overcomplete wavelet video coder. A video coding algorithm unit locates significant wavelet coefficients in a first video frame and temporally predicts location information for significant wavelet coefficients in a second video frame using motion information. The video coding algorithm unit is also capable of receiving and using spatial prediction information from spatial parents of the second video frame. The invention combines temporal prediction with spatial prediction to obtain a joint spatio-temporal prediction. The invention also establishes an order for encoding clusters of significant wavelet coefficients. The invention increases coding efficiency and provides an increased quality of decoded video.

The present invention is directed, in general, to digital signal transmission systems and, more specifically, to a system and method for employing joint spatio-temporal prediction techniques within an overcomplete wavelet video coding framework.

In digital video communications overcomplete wavelet video coding provides a very flexible and efficient framework for video transmission. Overcomplete wavelet video coding may be considered to be a generalization of previously existing interframe wavelet encoding techniques. By performing motion compensated temporal filtering, independently subband by subband, after the spatial decomposition in the overcomplete wavelet domain, problems with shift variance of the wavelet transform can be resolved.

Morphological significance map coding has been introduced for image coding where significant wavelet coefficients are clustered together using morphological operations. Two dimensional (2-D) morphological operations have been used to cluster significant wavelet coefficients and predict significance across different spatial scales. The morphological operations have been shown to be more robust in preserving important features like edges.

Previously existing applications of morphological significance coding to video consider different frames as independent images or independent residue frames. Therefore the prior art approaches do not efficiently exploit inter-frame dependencies.

There is therefore a need in the art for a system and method that is capable of applying morphological significance operations to video coding to provide an increase in coding efficiency. There is also a need in the art for a system and method that is capable of applying morphological significance operations to video coding to provide an increase in the quality of decoded video of wavelet based video coding schemes.

To address the deficiencies of the prior art mentioned above, the system and method of the present invention applies to video coding the temporal prediction of significant wavelet coefficients using motion information. The system and method of the present invention combines temporal prediction techniques with spatial prediction techniques to obtain a joint spatio-temporal prediction and morphological clustering scheme.

The system and method of the present invention comprises a video coding algorithm unit that is located within a video encoder of a video transmitter. The video coding algorithm unit locates significant wavelet coefficients in a first video frame and then temporally predicts location information for significant wavelet coefficients in a second video frame using motion information. The video coding algorithm unit then morphologically clusters the significant wavelet coefficients in the second video frame. In this manner the invention provides a system and method for joint spatio-temporal prediction of significant wavelet coefficients.

The video coding algorithm unit is also capable of receiving and using spatial prediction information from spatial parents of the second video frame. The video coding algorithm unit is also capable of receiving and using temporal prediction information from other temporal parents of the second video frame. The system and method of the invention is also capable of operating with bi-directional filtering and with multiple reference frames.

In one advantageous embodiment of the invention the video coding algorithm unit establishes an order for the efficient encoding of clusters of significant wavelet coefficients. Each cluster is assigned a cost factor. The cost factor C is a function of a rate R representing the number of bits that are needed to encode the cluster and a distortion reduction D. The clusters having a low value of cost factor are encoded first.

It is an object of the present invention to provide a system and method for applying to video coding the temporal prediction of significant wavelet coefficients using motion information.

It is another object of the present invention to provide a system and method in a digital video transmitter for digitally encoding video signals within an overcomplete wavelet video coding framework for locating clusters of significant wavelet coefficients using a joint spatio-temporal prediction method.

It is also an object of the present invention to provide a system and method in a digital video transmitter for digitally encoding video signals within an overcomplete wavelet video coding framework for locating clusters of significant wavelet coefficients using both spatial prediction information and temporal prediction information.

It is another object of the present invention to provide a system and method for creating residue subbands by filtering spatio-temporally filtered video frames through a high pass filter.

It is also an object of the present invention to provide a system and method for establishing an order for the efficient encoding of clusters of significant wavelet coefficients using a cost factor for each cluster that minimizes rate-distortion cost.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art should appreciate that they may readily use the conception and the specific embodiment disclosed as a basis for modifying or designing other structures for carrying out the same purposes of the present invention. Those skilled in the art should also realize that such equivalent constructions do not depart from the spirit and scope of the invention in its broadest form.

Before undertaking the Detailed Description of the Invention, it may be advantageous to set forth definitions of certain words and phrases used throughout this patent document: the terms “include” and “comprise” and derivatives thereof, mean inclusion without limitation; the term “or,” is inclusive, meaning and/or, the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller,” “processor,” or “apparatus” means any device, system or part thereof that controls at least one operation, such a device may be implemented in hardware, firmware or software, or some combination of at least two of the same. It should be noted that the functionality associated with any particular controller may be centralized or distributed, whether locally or remotely. In particular, a controller may comprise one or more data processors, and associated input/output devices and memory, that execute one or more application programs and/or an operating system program. Definitions for certain words and phrases are provided throughout this patent document. Those of ordinary skill in the art should understand that in many, if not most instances, such definitions apply to prior uses, as well as future uses, of such defined words and phrases.

For a more complete understanding of the present invention, and the advantages thereof, reference is now made to the following descriptions taken in conjunction with the accompanying drawings, wherein like numbers designate like objects, and in which:

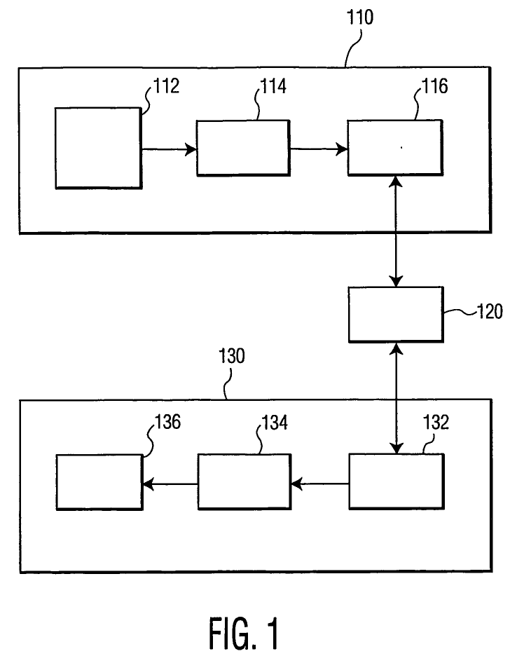

FIG. 1 is a block diagram illustrating an end-to-end transmission of steaming video from a streaming video transmitter through a data network to a streaming video receiver according to an advantageous embodiment of the present invention;

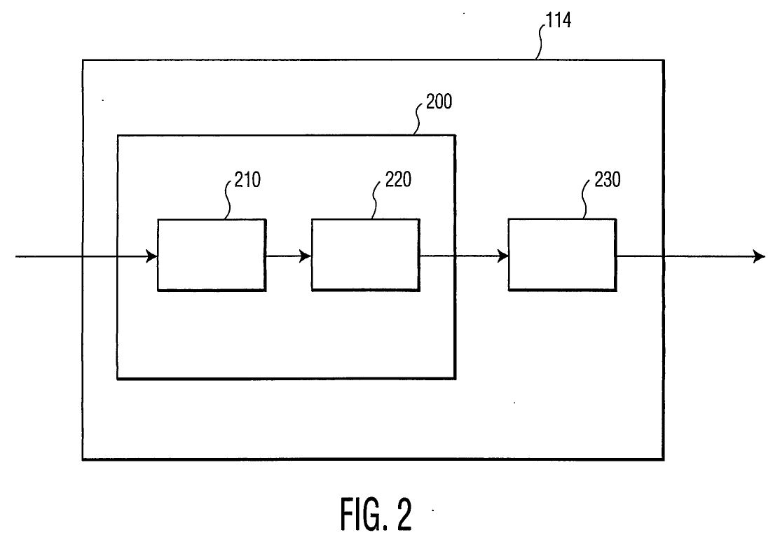

FIG. 2 is a block diagram illustrating an exemplary video encoder according to an advantageous embodiment of the present invention;

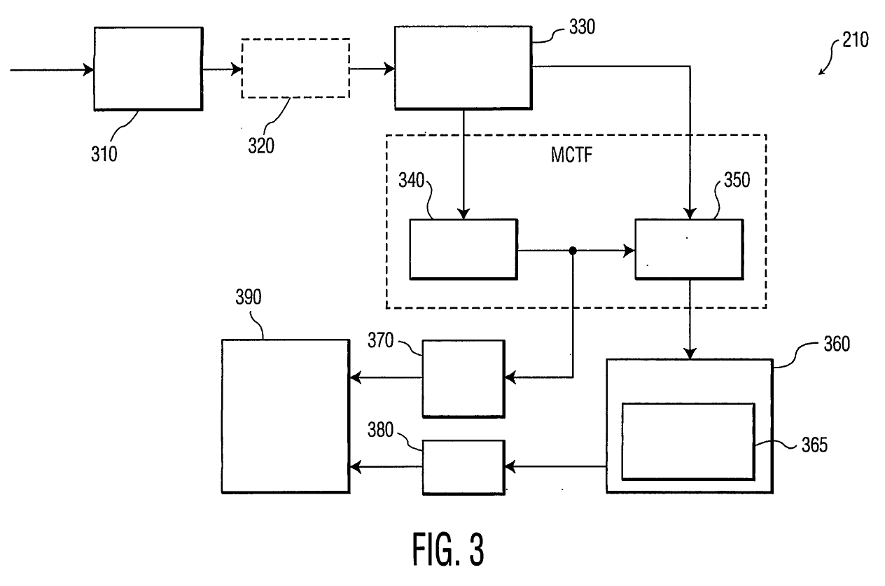

FIG. 3 is a block diagram an exemplary overcomplete wavelet coder according to an advantageous embodiment of the present invention;

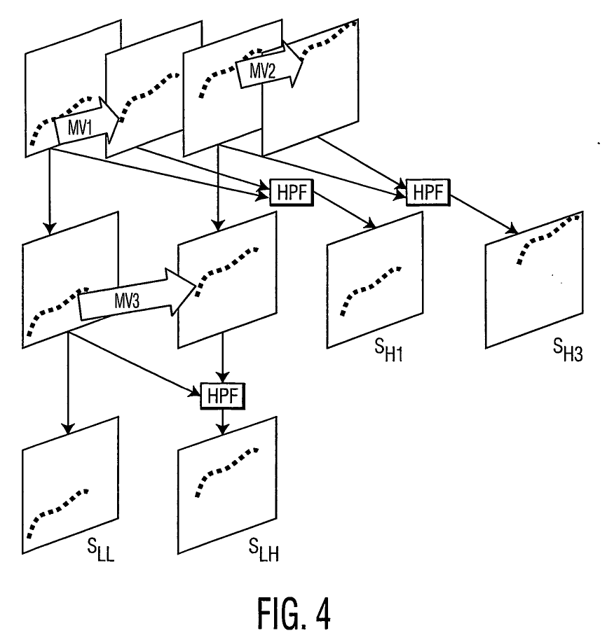

FIG. 4 is a diagram illustrating an example of how the present invention applies temporal filtering after spatial decomposition in four exemplary subbands;

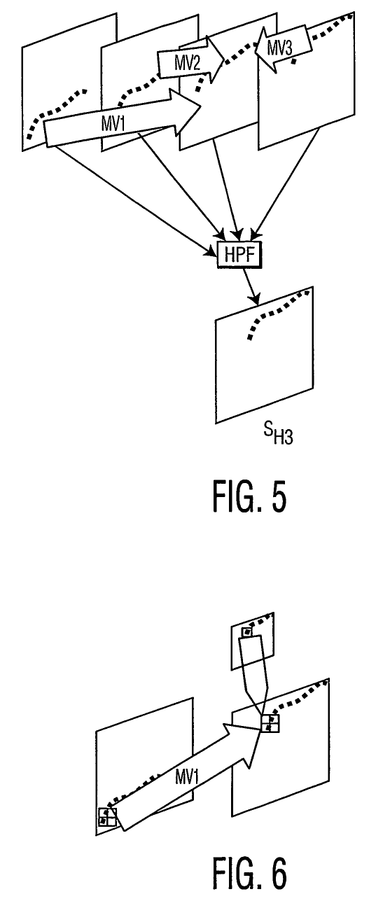

FIG. 5 is a diagram illustrating another example of the method of the present invention showing bi-directional filtering and the use of multiple references;

FIG. 6 is a diagram illustrating another example of the method of the present invention showing how the location of significant wavelet coefficients in a subband may be predicted from both a temporal parent and a spatial parent of the subband;

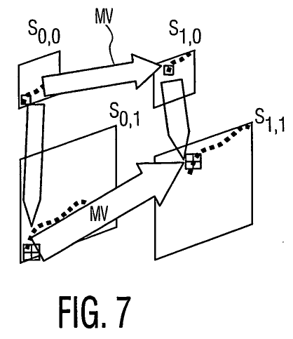

FIG. 7 is a diagram illustrating another example of the method of the present invention showing how clusters of significant wavelet coefficients may be ordered;

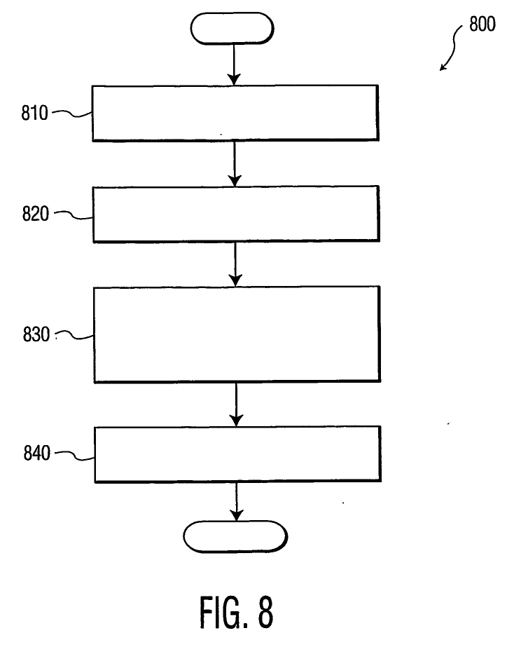

FIG. 8 illustrates a flowchart showing the steps of a first method of an advantageous embodiment of the present invention;

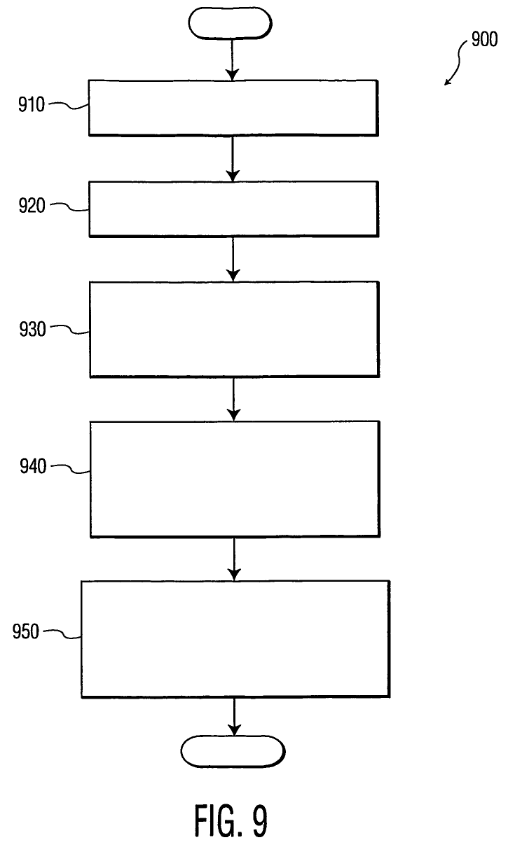

FIG. 9 illustrates a flowchart showing the steps of a second method of an advantageous embodiment of the present invention; and

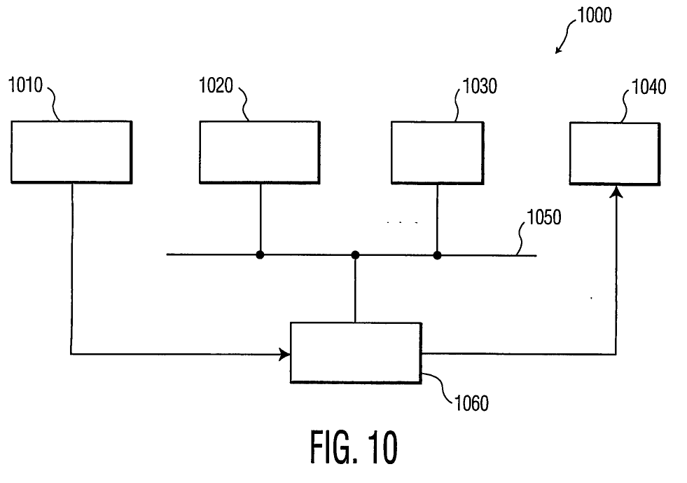

FIG. 10 illustrates an exemplary embodiment of a digital transmission system that may be used to implement the principles of the present invention.

FIGS. 1 through 10, discussed below, and the various embodiments used to describe the principles of the present invention in this patent document are by way of illustration only and should not be construed in any way to limit the scope of the invention. The present invention may be used in any digital video signal encoder or transcoder.

FIG. 1 is a block diagram illustrating an end-to-end transmission of streaming video from streaming video transmitter 110, through data network 120 to streaming video receiver 130, according to an advantageous embodiment of the present invention. Depending on the application, streaming video transmitter 110 may be any one of a wide variety of sources of video frames, including a data network server, a television station, a cable network, a desktop personal computer (PC), or the like.

Streaming video transmitter 110 comprises video frame source 112, video encoder 114 and encoder buffer 116. Video frame source 112 may be any device capable of generating a sequence of uncompressed video frames, including a television antenna and receiver unit, a video cassette player, a video camera, a disk storage device capable of storing a “raw” video clip, and the like. The uncompressed video frames enter video encoder 114 at a given picture rate (or “streaming rate”) and are compressed according to any known compression algorithm or device, such as an MPEG-4 encoder. Video encoder 114 then transmits the compressed video frames to encoder buffer 116 for buffering in preparation for transmission across data network 120. Data network 120 may be any suitable IP network and may include portions of both public data networks, such as the Internet, and private data networks, such as an enterprise owned local area network (LAN) or wide area network (WAN).

Streaming video receiver 130 comprises decoder buffer 132, video decoder 134 and video display 136. Decoder buffer 132 receives and stores streaming compressed video frames from data network 120. Decoder buffer 132 then transmits the compressed video frames to video decoder 134 as required. Video decoder 134 decompresses the video frames at the same rate (ideally) at which the video frames were compressed by video encoder 114. Video decoder 134 sends the decompressed frames to video display 136 for play-back on the screen of video display 136.

FIG. 2 is a block diagram illustrating an exemplary video encoder 114 according to an advantageous embodiment of the present invention. Exemplary video encoder 114 comprises source coder 200 and transport coder 230. Source coder 200 comprises waveform coder 210 and entropy coder 220. Video signals are provided from video frame source 112 (shown in FIG. 1) to source coder 200 of video encoder 114. The video signals enter waveform coder 210 where they are processed in accordance with the principles of the present invention in a manner that will be more fully described.

Waveform coder 210 is a lossy device that reduces the bitrate by representing the original video using transformed variables and applying quantization. Waveform coder 210 may perform transform coding using a discrete cosine transform (DCT) or a wavelet transform. The encoded video signals from waveform coder 210 are then sent to entropy coder 220.

Entropy coder 220 is a lossless device that maps the output symbols from waveform coder 210 into binary code words according to a statistical distribution of the symbols to be coded. Examples of entropy coding methods include Huffman coding, arithmetic coding, and a hybrid coding method that uses DCT and motion compensated prediction. The encoded video signals from entropy coder 220 are then sent to transport coder 230.

Transport coder 230 represents a group of devices that perform channel coding, packetization and/or modulation, and transport level control using a particular transport protocol. Transport coder 230 coverts the bit stream from source coder 200 into data units that are suitable for transmission. The video signals that are output from transport coder 230 are sent to encoder buffer 116 for ultimate transmission through data network 120 to video receiver 130.

FIG. 3 is a block diagram illustrating an exemplary overcomplete wavelet coder 210 according to an advantageous embodiment of the present invention. Overcomplete wavelet coder 210 comprise a branch that comprises a discrete wavelet transform unit 310 that generates a wavelet transform of a current frame 320, and a complete to overcomplete discrete wavelet transform unit 330. A first output of complete to overcomplete discrete wavelet transform unit 330 is provided to motion estimation unit 340. A second output of complete to overcomplete discrete wavelet transform unit 330 is provided to temporal filtering unit 350. Together motion estimation unit 340 and temporal filtering unit 350 provide motion compensated temporal filtering (MCTF). Motion estimation unit 340 provides motion vectors (and frame reference numbers) to temporal filtering unit 350.

Motion estimation unit 340 also provides motion vectors (and frame reference numbers) to motion vector coder unit 370. The output of motion vector coder unit 370 is provided to transmission unit 390. The output of temporal filtering unit 350 is provided to subband coder 360. Subband coder 360 comprises video coding algorithm unit 365. Video coding algorithm unit 365 comprises an exemplary structure for operating the video coding algorithm of the present invention. The output of subband coder 360 is provided to entropy coder 380. The output of entropy coder 380 is provided to transmission unit 390. The structure and operation of the other various elements of overcomplete wavelet coder 210 are well known in the art.

Two dimensional (2-D) morphological significance coding has previously been applied to video. An example is set forth and described in a paper by J. Vass et al. entitled “Significance-Linked Connected Component Analysis for Very Low Bit-Rate Wavelet Video Coding,” published in IEEE Transactions on Circuits and Systems for Video Technology, Volume 9, Pages 630-647, June 1999. The Vass system first applies a temporal filter and then clusters the temporally filtered frames by using a two dimensional (2-D) morphological significance coding. The Vass system considers the different video frames as independent images or independent residue frames. The Vass system does not efficiently exploit inter-frame dependencies.

Other prior art systems have applied similar morphological significance coding techniques. See, for example, a paper by S. D. Servetto et al. entitled “Image Coding Based on a Morphological Representation of Wavelet Data,” published in IEEE Transactions on Circuits and Systems for Video Technology, Volume 8, Pages 1161-1174, September 1999.

In contrast to the prior art, the present invention combines morphological significance coding techniques with temporal prediction of significant wavelet coefficients using motion information. As will be more fully described, the system and method of the present invention is capable of identifying and spatially clustering significant wavelet coefficients in a first frame, temporally predicting the location of the clusters in a second frame using motion information, and then spatially clustering the significant wavelet coefficients in the second frame. The video coding algorithm of the present invention (1) increases coding efficiency, and (2) increases the decoded video quality of wavelet based video coding schemes.

In order to better understand the operation of the present invention, consider the following example. FIG. 4 illustrates one advantageous embodiment of how temporal filtering may be applied after spatial decomposition. FIG. 4 illustrates four exemplary subbands obtained at the same scale after applying a spatial wavelet transform process to four consecutive frames. The four subbands are designated Subband 0, Subband 1, Subband 2, and Subband 3. Subband 0, Subband 1, Subband 2, and Subband 3 will also be designated with reference numerals 410, 420, 430 and 440, respectively. In FIG. 4, a line of dark dots in a subband represents a cluster of significant wavelet coefficients. Significant wavelet coefficients may represent, for example, an edge of a moving object in the video representation.

The method of the invention spatially clusters the significant wavelet coefficients in frame 410 (i.e., obtains a significance map of the significant wavelet coefficients in frame 410). Then the method uses motion information (represented by motion vector MV1) to temporally predict the location of the clusters of significant wavelet coefficients in frame 420. That is, frame 410 is temporally filtered in the direction of motion. The temporal filter may be a prior art temporal filter such as a temporal multi-resolution decomposition filter. Then the method spatially clusters the significant wavelet coefficients in frame 420 (i.e., obtains a significance map of the significant wavelet coefficients in frame 410). Then the data for frame 410 is encoded.

The method also spatially clusters the significant wavelet coefficients in frame 430 (i.e., obtains a significance map of the significant wavelet coefficients in frame 430). Then the method uses motion information (represented by motion vector MV2) to temporally predict the location of the clusters of significant wavelet coefficients in frame 440. That is, frame 430 is temporally filtered in the direction of motion. Then the method spatially clusters the significant wavelet coefficients in frame 440 (i.e., obtains a significance map of the significant wavelet coefficients in frame 440). Then the data for frame 440 is encoded.

FIG. 4 also illustrates how the location of the clusters of significant wavelet coefficients in frame 430 may be located using frame 410. As before, the method spatially clusters the significant wavelet coefficients in frame 410 (i.e., obtains a significance map of the significant wavelet coefficients in frame 410). Then the method uses motion information (represented by motion vector MV3) to temporally predict the location of the clusters of significant wavelet coefficients in frame 430. That is, frame 430 is temporally filtered in the direction of motion. Then the method spatially clusters the significant wavelet coefficients in frame 430 (i.e., obtains a significance map of the significant wavelet coefficients in frame 430). Then the data for frame 430 is encoded.

FIG. 4 also illustrates how spatio-temporally filtered subbands may be generated. Information concerning the location of clusters of significant wavelet coefficients in frame 410 and in frame 420 are provided to a high pass filter (HPF). The high pass filter filters the information to create decomposed frame 450 (also designated SHI). Frame 450 represents the residue resulting from the subtraction of frame 420 subtracted from frame 410 (i.e., the residue of Subband 1 from Subband 0). Then the data for frame 450 is encoded.

Similarly, information concerning the location of clusters of significant wavelet coefficients in frame 430 and in frame 440 are provided to a high pass filter (HPF). The high pass filter filters the information to create decomposed frame 460 (also designated S_{H3}). Frame 460 represents the residue resulting from the subtraction of frame 440 subtracted from frame 430 (i.e., the residue of Subband 3 from Subband 2). Then the data for frame 460 is encoded.

The residue subbands (frame 450 and frame 460) are likely to have much less energy than the original subbands. Therefore, a cluster of significant wavelet coefficients is represented by a line of lighter dots in the residue subbands. However, due to imperfect motion predictions, the significant wavelet coefficients continue to lie in the vicinity of the edges (spatial detail).

FIG. 4 also illustrates how a residue subband (frame 470) may be generated from frame 410 and frame 430. Information concerning the location of clusters of significant wavelet coefficients in frame 410 and in frame 430 are provided to a high pass filter (HPF). The high pass filter filters the information to create decomposed frame 470 (also designated S_{LH}). Frame 470 represents the residue resulting from the subtraction of frame 430 subtracted from frame 410 (i.e., the residue of Subband 2 from Subband 0). Then the data for frame 470 is encoded. Lastly, the data in frame 410 in Subband 0 (also designated S_{LL}) is encoded.

The process described above may be set forth in a pseudo-code for coding the four subbands (S_{LL}, S_{LH}, S_{H1}, S_{H3}) using temporal prediction. The pseudo-code is as follows:

(1) Subband S_{LL}. Start with a random seed to identify a location of a significant wavelet coefficient Use morphological filtering to cluster the significant wavelet coefficients. Obtain the significance map. Encode the data for S_{LL}.

(2) Subband S_{LH}. Predict the location of significant wavelet coefficients in S_{LH} (Subband 0) using motion vector MV3 and the cluster location in S_{LL}. Build the significance map for S_{LH} using the prediction. Encode the data for S_{LH}.

(3) Subband S_{H1}. Predict the location of significant wavelet coefficients in Subband 0 using motion vector MV1 and the cluster location in S_{LL}. Build the significance map for S_{H1} using the prediction. Encode the data for S_{H1}.

(4) Subband S_{H3}. Predict the location of significant wavelet coefficients in Subband 2 using motion vector MV2 and the cluster location in S_{LH}. Build the significance map for S_{H3} using the prediction. Encode the data for S_{H3}.

The method of the present invention not only predicts across different scales using morphological clustering, but also predicts across frames. This more efficiently exploits the temporal redundancy in the data.

The example shown in FIG. 4 is illustrative. The method of the invention is not limited to the features shown in the example of FIG. 4. FIG. 4 shows the application of the method of the invention to a two-level decomposition with four frames. The method of the invention is also applicable to other levels of decomposition of other numbers of frames. In particular, the method of the invention may be applied to situations in which more than one subband is used as a reference (multiple references). The method of the invention may also be applied in situations where bi-directional filtering is used. The method of the invention may also be applied in various other scenarios within a temporal filtering network.

FIG. 5 illustrates another advantageous embodiment of how temporal filtering may be applied after spatial decomposition. FIG. 5 illustrates four exemplary subbands obtained at the same scale after applying a spatial wavelet transform process to four consecutive frames. The four subbands are designated Subband 0, Subband 1, Subband 2, and Subband 3. Subband 0, Subband 1, Subband 2, and Subband 3 will also be designated with reference numerals 510, 520, 530 and 540, respectively. In FIG. 5, a line of dark dots in a subband represents a cluster of significant wavelet coefficients. Significant wavelet coefficients may represent, for example, an edge of a moving object in the video representation.

FIG. 5 illustrates how the method of the invention operates in a situation that involves multiple reference frames and bi-directional filtering. The method of the invention spatially clusters the significant wavelet coefficients in frame 510 (i.e., obtains a significance map of the significant wavelet coefficients in frame 510). Then the method uses motion information (represented by motion vector MV1) to temporally predict the location of the clusters of significant wavelet coefficients in frame 430. That is, frame 510 is temporally filtered in the direction of motion.

The method of the invention spatially clusters the significant wavelet coefficients in frame 520 (i.e., obtains a significance map of the significant wavelet coefficients in frame 520). Then the method uses motion information (represented by motion vector MV2) to temporally predict the location of the clusters of significant wavelet coefficients in frame 530. That is, frame 520 is temporally filtered in the direction of motion.

The method of the invention spatially clusters the significant wavelet coefficients in frame 540 (i.e., obtains a significance map of the significant wavelet coefficients in frame 540). Then the method uses motion information (represented by motion vector MV3) to temporally predict the location of the clusters of significant wavelet coefficients in frame 530. That is, frame 530 is temporally filtered in the direction of motion. Motion vector MV3 extends from frame 540 to frame 530. Motion vector MV3 is opposite in direction to motion vector MV1 and motion vector MV2.

Information concerning the location of the clusters of significant wavelet coefficients in frame 510, frame 520, frame 530 and frame 540 are provided to a high pass filter (HPF). The high pass filter filters the information to create decomposed frame 550 (also designated S_{H3}). The method of the invention spatially clusters the significant wavelet coefficients in frame 550 (i.e., obtains a significance map of the significant wavelet coefficients in frame 550). Then the data for frame 550 is encoded.

The process described above may be set forth in a pseudo-code for coding the subband S_{H3} using temporal prediction. The pseudo-code is as follows:

(1) Subband S_{H3}. Predict the location of significant wavelet coefficients in S_{H3} using the motion vectors MV1, MV2 and MV3 and the location of the clusters of significant wavelet coefficients in frame 510, frame 520, and frame 540. Use morphological filtering to cluster the significant wavelet coefficients and obtain the significance map for S_{H3} using the combined prediction. Encode the data for S_{H3}.

Other embodiments of the method of the invention may be extended to cover situations that involve variable decomposition structures, multiple references, and the like.

FIG. 6 illustrates another advantageous embodiment of how temporal filtering may be applied after spatial decomposition and used to predict the location of significant wavelet coefficients in a subband from both a temporal parent and a spatial parent of the subband. FIG. 6 illustrates a current subband (represented by frame 610), a temporal parent of the current subband (represented by frame 620) and a spatial parent of the current subband (represented by frame 630).

This embodiment of the method of the invention combines the prediction of significant wavelet coefficients across spatial scales with the prediction of significant wavelet coefficients across temporal frames. That is, the position of the significant wavelet coefficients in frame 610 may be predicted from both the temporal parent (frame 620) or the spatial parent (frame 630). The predictions from both the temporal parent (frame 620) and the spatial parent (frame 630) are combined to increase the robustness of the prediction and improve the coding efficiency.

The temporal parent prediction and the spatial parent prediction may be combined in three specific combinations.

The first combination is an “or” combination. The locations of the wavelet coefficients in frame 610 are labeled “significant” (1) if the temporal parent prediction says the coefficients are significant, or (2) if the spatial parent prediction says the coefficients are significant.

The second combination is an “and” combination. The locations of the wavelet coefficients in frame 610 are labeled “significant” (1) if the temporal parent prediction says the coefficients are significant, and (2) if the spatial parent prediction says the coefficients are significant.

The third combination is a “voting” combination. The locations of the wavelet coefficients in frame 610 are labeled “significant” if a majority of the temporal parent predictions says that the coefficients are significant. The “voting” combination is applicable to situations where there is more than one temporal parent

In prior art systems data that represented significant wavelet coefficients was organized into rigid spatial hierarchies like zerotrees or the subbands were coded independently. In one advantageous embodiment the method of the invention employs morphological clustering using joint spatio-temporal prediction. This produces inter-related clusters that may be organized more flexibly to achieve better rate-distortion performance.

A cost factor C may be associated with each morphological cluster. The cost factor C depends upon the number of bits needed to code the cluster (i.e., the rate R) and the distortion reduction D that is obtained by coding the cluster. A useful expression for the cost factor C in terms of R and D is as follows:
C=R+λD (1)

where the factor lambda (λ) represents a Lagrange multiplier. The value of lambda may be set by the user or may be optimized by the video coding algorithm of the invention for a given constraint The rate R may be measured in terms of the number of bits needed to code a cluster. The distortion reduction D may be measured in terms of quality metrics such as squared reconstruction error. In an alternate embodiment the cost factor C may also include a measurement of the impact of the cluster on the overall coding performance (e.g., reduction in drift).

It is desirable to determine an optimal order for encoding the clusters. In order to achieve maximum gain and reduce distortion the clusters that have a low cost factor C should be encoded (and transmitted) first. There is a tradeoff between the amount of distortion reduction D that may be achieved by encoding a cluster and the number of bits (rate R) needed to encode the cluster. The method of the invention codes the clusters in an order that minimizes the rate-distortion cost factor C. The minimization of the rate-distortion cost factor C may be performed bitplane by bitplane.

The method of the invention for ordering the clusters for encoding provides a flexible, efficient and fine granular adaptation to variations in the rate R, while preserving the embeddedness of the video coding scheme.

An advantageous embodiment of the method of the invention for ordering the clusters is shown as an example in FIG. 7.

FIG. 7 illustrates a current subband S_{1,1} (represented by frame 710), a temporal parent S_{0,1} of the current subband S_{1,1} (represented by frame 720), a spatial parent S_{1,0} of the current subband S_{1,1} (represented by frame 730), and a spatial parent S_{0,0} (represented by frame 740) for both spatial parent S_{1,0} and temporal parent S_{0,1}.

Motion vector 750 provides motion information for temporally filtering frame 720 to locate clusters of significant wavelet vectors in frame 710. Motion vector 760 provides motion information for temporally filtering frame 740 to locate clusters of significant wavelet vectors in frame 730.

An exemplary process utilizing the method of the invention in conjunction with the elements of FIG. 7 may be illustrated with pseudo-code. The pseudo-code is as follows:

1. Locate and code cluster M_{0,0} within frame 740.

2. Predict cluster M_{0,1} in frame 720 using cluster M_{0,0}.

3. Predict cluster M_{1,0} in frame 730 using cluster M_{0,0}.

4. Compute Cost Factor C_{0,1} for cluster M_{0,1}.

5. Compute Cost Factor C_{1,0} for cluster M_{1,0}.

6. Compare Cost Factors C_{0,1} and C_{1,0}.

7. If C_{0,1} is less than C_{1,0} encode M_{0,1} first, then M_{0,1}.

8. If C_{1,0} is less than C_{0,1} encode M_{1,0} first, then M_{0,1}.

9. Predict cluster M_{1,1} in frame 710 using M_{1,0} and M_{0,1}.

10. Code cluster M_{1,1} within frame 710.

The exemplary method described in the pseudo-code shows that the cluster with the smallest value of cost factor is encoded first. The method of the invention provides an efficient and flexible structure for ordering the encoding of clusters using an optimized rate-distortion cost factor.

FIG. 8 illustrates a flowchart showing the steps of a first method of an advantageous embodiment of the present invention. The steps are collectively referred to with reference numeral 800. In the first step of the method the video coding algorithm of the present invention scans a subband in a raster scan order until a first significant wavelet coefficient is located in a first frame (step 810). Then the video coding algorithm spatially clusters the significant wavelet coefficients in the first frame (step 820).

The algorithm then temporally predicts the location of a cluster of significant wavelet coefficients in a second frame using motion information (step 830). The algorithm then spatially clusters the significant wavelet coefficients in the second frame (step 840).

FIG. 9 illustrates a flowchart showing the steps of a second method of an advantageous embodiment of the present invention for providing a joint-spatio-temporal prediction of significant wavelet coefficients. The steps are collectively referred to with reference numeral 900. In the first step of the method the video coding algorithm of the present invention scans a subband in a raster scan order until a first significant wavelet coefficient is located in a first frame (step 910). Then the video coding algorithm spatially clusters the significant wavelet coefficients in the first frame (step 920).

The algorithm then temporally predicts the location of a cluster of significant wavelet coefficients in a second frame using motion information (step 930). The algorithm then spatially predicts the location of the cluster of significant wavelet coefficients in the second frame from a spatial parent of the second frame (step 940). The algorithm then identifies the location of the cluster of significant wavelet coefficients in the second frame using the temporal prediction and/or the spatial prediction (step 950).

FIG. 10 illustrates an exemplary embodiment of a system 1000 which may be used for implementing the principles of the present invention. System 1000 may represent a television, a set-top box, a desktop, laptop or palmtop computer, a personal digital assistant (PDA), a video/image storage device such as a video cassette recorder (VCR), a digital video recorder (DVR), a TiVO device, etc., as well as portions or combinations of these and other devices. System 1000 includes one or more video/image sources 1010, one or more input/output devices 1060, a processor 1020 and a memory 1030. The video/image source(s) 1010 may represent, e.g., a television receiver, a VCR or other video/image storage device. The video/image source(s) 1010 may alternatively represent one or more network connections for receiving video from a server or servers over, e.g., a global computer communications network such as the Internet, a wide area network, a terrestrial broadcast system, a cable network, a satellite network, a wireless network, or a telephone network, as well as portions or combinations of these and other types of networks.

The input/output devices 1060, processor 1020 and memory 1030 may communicate over a communication medium 1050. The communication medium 1050 may represent, e.g., a bus, a communication network, one or more internal connections of a circuit, circuit card or other device, as well as portions and combinations of these and other communication media Input video data from the source(s) 1010 is processed in accordance with one or more software programs stored in memory 1030 and executed by processor 1020 in order to generate output video/images supplied to a display device 1040.

In a preferred embodiment, the coding and decoding employing the principles of the present invention may be implemented by computer readable code executed by the system. The code may be stored in the memory 1030 or read/downloaded from a memory medium such as a CD-ROM or floppy disk. In other embodiments, hardware circuitry may be used in place of, or in combination with, software instructions to implement the invention. For example, the elements illustrated herein may also be implemented as discrete hardware elements.

While the present invention has been described in detail with respect to certain embodiments thereof, those skilled in the art should understand that they can make various changes, substitutions modifications, alterations, and adaptations in the present invention without departing from the concept and scope of the invention in its broadest form.

1. An apparatus (365) in a digital video transmitter (110) for digitally encoding video signals within an overcomplete wavelet video coder (210), said apparatus (365) comprising a video coding algorithm unit (365) that is capable of using location information of significant wavelet coefficients in a first video frame and motion information to temporally predict location information of significant wavelet coefficients in a second video frame.

2. An apparatus (365) as claimed in claim 1 wherein said motion information comprises a motion vector between said first video frame and said second video frame.

3. An apparatus (365) as claimed in claim 1 wherein said video coding algorithm unit (365) is further capable of receiving spatial prediction information from a spatial parent of said second frame and predicting location information of significant wavelet coefficients in said second video frame using one of: spatial prediction information from said spatial parent and temporal prediction information derived using said motion information.

4. An apparatus (365) as claimed in claim 3 wherein said video coding algorithm unit (365) identifies location information of significant wavelet coefficients in said second video frame when said temporal prediction information predicts a location for said significant wavelet coefficients in said second video frame and/or when said spatial prediction information predicts a location for said significant wavelet coefficients in said second video frame.

5. An apparatus (365) as claimed in claim 3 wherein said video coding algorithm unit (365) is capable of receiving temporal prediction information from a plurality of temporal parents of said second video frame and identifying location information of significant wavelet coefficients in said second video frame when a majority of said plurality of said temporal parents predict a location for said significant wavelet coefficients in said second video frame.

6. An apparatus (365) as claimed in claim 3 wherein said video coding algorithm unit (365) is further capable of receiving location information of significant wavelet coefficients from each of a plurality of video frames and motion information for each of said plurality of video frames and using said location information and said motion information to temporally predict location information of significant wavelet coefficients in said second video frame.

7. An apparatus (365) as claimed in claim 6 wherein a first portion of said plurality of video frames occur before said second video frame and a second portion of said plurality of video frames occur after said second video frame.

8. An apparatus (365) as claimed in claim 6 wherein said video coding algorithm unit (365) is further capable of creating at least one residue subband by filtering at least one spatio-temporally filtered video frame through a high pass filter.

9. An apparatus (365) as claimed in claim 1 wherein said video coding algorithm unit (365) is further capable of establishing an order for encoding clusters of significant wavelet coefficients using a cost factor C for each cluster where C is expressed as:
C=R+λD
where R represents a number of bits needed to code a cluster and D represents a distortion reduction D that is obtained by coding the cluster and lambda (λ) represents a Lagrange multiplier.

10. A method for digitally encoding video signals within an overcomplete wavelet video coder (210) in a digital video transmitter (110), said method comprising the steps of:
locating significant wavelet coefficients in a first video frame; and
temporally predicting location information of significant wavelet coefficients in a second video frame using location information of said significant wavelet coefficients in said first video frame and motion information.

11. A method as claimed in claim 10 wherein said motion information comprises a motion vector between said first video frame and said second video frame.

12. A method as claimed in claim 10 further comprising the steps of:
obtaining spatial prediction information from a spatial parent of said second frame; and
predicting location of significant wavelet coefficients in said second video frame using one of: spatial prediction information from said spatial parent and temporal prediction information derived using said motion information.

13. A method as claimed in claim 12 further comprising the steps of:
determining that said temporal prediction information predicts a location for said significant wavelet coefficients in said second video frame and/or determining that said spatial prediction information predicts a location for said significant wavelet coefficients in said second video frame; and
identifying location information of significant wavelet coefficients in said second video frame.

14. A method as claimed in claim 12 further comprising the steps of:
obtaining temporal prediction information from a plurality of temporal parents of said second video frame;
determining that a majority of said plurality of said temporal parents predict a location for said significant wavelet coefficients in said second video frame; and
identifying location information of significant wavelet coefficients in said second video frame based on said prediction of said majority of said temporal parents of said second video frame.

15. A method as claimed in claim 12 further comprising the steps of:
obtaining location information of significant wavelet coefficients from each of a plurality of video frames;
obtaining motion information for each of said plurality of video frames; and
temporally predicting location information of significant wavelet coefficients in said second video frame using said location information and said motion information.

16. A method as claimed in claim 15 wherein a first portion of said plurality of video frames occur before said second video frame and a second portion of said plurality of video frames occur after said second video frame.

17. A method as claimed in claim 15 further comprising the step of:
creating at least one residue subband by filtering at least one spatio-temporally filtered video frame through a high pass filter.

18. A method as claimed in claim 10 further comprising the step of:
establishing an order for encoding clusters of significant wavelet coefficients using a cost factor C for each cluster where C is expressed as:
C=R+λD
where R represents a number of bits needed to code a cluster and D represents a distortion reduction D that is obtained by coding the cluster and lambda (λ) represents a Lagrange multiplier.

19. A digitally encoded video signal generated by a method for digitally encoding video signals within an overcomplete wavelet video coder (210) in a digital video transmitter (110), said method comprising the steps of:
locating significant wavelet coefficients in a first video frame; and
temporally predicting location information of significant wavelet coefficients in a second video frame using location information of said significant wavelet coefficients in said first video frame and motion information.

20. A digitally encoded video signal as claimed in claim 19 wherein said motion information comprises a motion vector between said first video frame and said second video frame.

21. A digitally encoded video signal as claimed in claim 19 wherein said method further comprises the steps of:
obtaining spatial prediction information from a spatial parent of said second frame; and
predicting location of significant wavelet coefficients in said second video frame using one of: spatial prediction information from said spatial parent and temporal prediction information derived using said motion information.

22. A digitally encoded video signal as claimed in claim 21 wherein said method further comprises the steps of:
determining that said temporal prediction information predicts a location for said significant wavelet coefficients in said second video frame and/or determining that said spatial prediction information predicts a location for said significant wavelet coefficients in said second video frame; and
identifying location information of significant wavelet coefficients in said second video frame.

23. A digitally encoded video signal as claimed in claim 21 wherein said method further comprises the steps of:
obtaining temporal prediction information from a plurality of temporal parents of said second video frame;
determining that a majority of said plurality of said temporal parents predict a location for said significant wavelet coefficients in said second video frame; and
identifying location information of significant wavelet coefficients in said second video frame based on said prediction of said majority of said temporal parents of said second video frame.

24. A digitally encoded video signal as claimed as claimed in claim 21 wherein said method further comprises the steps of:
obtaining location information of significant wavelet coefficients from each of a plurality of video frames;
obtaining motion information for each of said plurality of video frames; and
temporally predicting location information of significant wavelet coefficients in said second video frame using said location information and said motion information.

25. A digitally encoded video signal as claimed in claim 24 wherein a first portion of said plurality of video frames occur before said second video frame and a second portion of said plurality of video frames occur after said second video frame.

26. A digitally encoded video signal as claimed in claim 24 wherein said method further comprises the step of:
creating at least one residue subband by filtering at least one spatio-temporally filtered video frame through a high pass filter.

27. A digitally encoded video signal as claimed in claim 19 wherein said method further comprises the step of:
establishing an order for encoding clusters of significant wavelet coefficients using a cost factor C for each cluster where C is expressed as:
C=R+λD
where R represents a number of bits needed to code a cluster and D represents a distortion reduction D that is obtained by coding the cluster and lambda (λ) represents a Lagrange multiplier.
